(19) United States
(12) Patent Application Publication
(10) Pub. No.: US 2007/0119674 A1
(43) Pub. Date: May 31, 2007

(54) Lockup clutch

(75) Inventor: Ritsuo Toya, Fukuroi-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK-Warner K.K., Shinagawa-ku (JP)

(21) Appl. No.: 11/603,090

(22) Filed: Nov. 22, 2006

(30) Foreign Application Priority Data
Nov. 25, 2005 (JP) 2005-340492

(51) Int. Cl. F16H 45/02

(52) U.S. Cl. 192/3.29; 192/107 R

(57) ABSTRACT

A lockup clutch for a torque converter is provided with a friction lining. The friction lining is divided into a radially-outer-side friction lining and a radially-inner-side friction lining. μ-ν characteristics of the radially-outer-side friction lining have a positive gradient to inhibit occurrence of a shudder which takes place by a stick-slip. The radially-inner-side friction lining is equipped with a large coefficient of static friction to provide large torque capacity during a clutch engagement. The radially-outer-side friction lining is provided with plural grooves formed with intervals therebetween in a circumferential direction or is provided with a continuous groove formed alongside an entire circumference thereof in the circumferential direction.

### FIELD OF THE INVENTION

This invention relates to improvements in a lockup clutch, which is useful in a torque converter of an automatic transmission and can inhibit a shudder which take place by a stick-slip.

### DESCRIPTION OF THE BACKGROUND

FIG. 1 is a cross-sectional view showing the fundamental construction of a torque converter equipped with a lockup clutch. A torque converter 10 comprises a pump section 2, a turbine section 3, and a stator 4. FIG. 1 also illustrates a front cover 21, an outer shell 22, blades 23 and an inner core 24 of the pump section 2, an outer shell 32, blades 33 and an inner core 34 of the turbine section 3, and a turbine hub 35.

Also shown in FIG. 1 are a clutch piston 5, a damper support portion 51, a damper 52, a damper plate 53 and a damper spring 54 of the lockup clutch. The outer shell 32 of the turbine section 3, the turbine hub 35 and the damper plate 53 are joined together by a rivet 55. Designated at numeral 56 is a hole located centrally in the piston 5, and through the hole 56, the turbine hub 35 extends. Numeral 7 indicates a friction lining bonded on a clutch-engaging portion of the clutch piston 5. It is to be noted that this friction lining may be bonded on the side of the front cover 21. Numeral 6 designates a coupling welded on the front cover 21 and adapted to connect the torque converter to an engine. An alternate long-and-short dash line X-X indicates a central axis of the whole torque converter.

In recent years, there is an increasing tendency toward actuating a lockup clutch even from a low vehicle-speed range to improve the fuel economy. Reflecting this tendency, slip control is increasingly performed these days. In such slip control, the lockup clutch involves a problem in that a clutch piston and a damper or the like act as a shuddering body and a resilient body, respectively, and vibrations called a shudder occur as a result of a stick-slip of a friction lining.

A friction lining is formed from fibers, a filler, a friction modifier, and a resin dissolved in a solvent. As the solvent evaporates, the resin located inside the green friction lining progressively moves together with the solvent close to the surface. A high resin-proportion layer with the resin contained at a high concentration is, therefore, formed near the surface of the friction lining. The friction lining has a high coefficient of friction when the slip rotation speed is low, but a low coefficient of friction when the slip rotation speed becomes high. In other words, the μ-ν characteristics of the friction lining have a negative gradient, thereby causing a shudder by a stick-slip when the clutch is brought into engagement. It is to be noted that the expression “slip rotation speed” as used herein means a difference in rotation speed between a member with a friction lining bonded thereon and another member having a counterpart friction surface.

It has, therefore, been a conventional practice to remove the high resin-proportion layer from the surface of the friction lining and further to subject the friction lining to cutting on the side of its outer circumference such that the surface is rendered smooth. This cutting is usually performed in automatic transmission fluid. The automatic transmission fluid, therefore, adheres to the product, leading to a deterioration in the working environment. Moreover, the need for the cutting results in higher manufacturing cost.

It was, therefore, contemplated to divide a friction lining into a radially-outer-side friction lining and a radially-inner-side friction lining, to make the proportion of a filler higher in the radially-outer-side friction lining than in the radially-inner-side friction lining to provide the μ-ν characteristics of the radially-outer-side friction lining with a positive gradient, in other words, such that the coefficient of friction becomes higher with the slip rotation speed to inhibit a shudder which takes place by a stick-slip; and further, to make higher the proportion of fibers in the radially-inner-side friction lining to provide the radially-inner-side friction lining with flexibility and to increase the sealing property and contact area of its friction surface and hence the coefficient of static friction, thereby making the lock-up capacity greater.

As a result of research, it became clear that among fillers, it is diatomaceous earth that is effective for the inhibition of a shudder. Recently, there is a tendency toward referring a combination of a filler and a friction modifier simply as “a filler”.

It was also found that, even if the proportion of fibers is not made specifically higher in a radially-inner-side friction lining than in a radially-outer-side friction lining, the coefficient of static friction of the radially-inner-side friction lining can still be made higher than that of the radially-outer-side friction lining by adjusting the proportion of the filler including a friction modifier.

FIG. 2 is a front view of the friction lining 7 bonded on the piston 5 as viewed at a friction surface of the piston 5, while FIG. 3 is a cross-sectional view taken in the direction arrows III-III of FIG. 2. FIGS. 2 and 3 show a radially-outer-side friction lining 71, a radially-inner-side friction lining 72, and a seam 73 between the friction lining 71 and the friction lining 72.

FIGS. 4 and 5 illustrate characteristics of the above-mentioned friction linings. FIG. 4 shows a positive gradient, and the slip rotation speed and the torque vary in the same direction. FIG. 5 shows a negative gradient, the coefficient of static friction is large, and as the slip rotation speed becomes lower, the torque increases conversely. It has, therefore, been the conventional practice to provide the radially-outer-side friction lining with μ-ν characteristics of positive gradient, for example, by increasing the proportion of diatomaceous earth in its filler and also to provide the radially-inner-side friction lining with a larger coefficient of static friction by adjusting the composition of its filler including a friction modifier. Keeping a step with the recent move toward lock-up clutches of higher performance, however, there is an outstanding demand for further functional enhancements.

### SUMMARY OF THE INVENTION

In one aspect of the present invention, there is thus provided a lockup clutch for a torque converter, wherein a friction lining is divided into a radially-outer-side friction lining and a radially-inner-side friction lining, μ-ν characteristics of the radially-outer-side friction lining have a positive gradient to inhibit occurrence of a shudder which takes place by a stick-slip, the radially-inner-side friction lining is equipped with a large coefficient of static friction to provide large torque capacity during a clutch engagement, and the radially-outer-side friction lining is provided with plural grooves formed with intervals therebetween formed in a circumferential direction.

In another aspect of the present invention, there is also provided a lockup clutch for a torque converter, wherein a friction lining is divided into a radially-outer-side friction lining and a radially-inner-side friction lining, μ-ν characteristics of the radially-outer-side friction lining have a positive gradient to inhibit occurrence of a shudder which takes place by a stick-slip, the radially-inner-side friction lining is equipped with a large coefficient of static friction to provide large torque capacity during a clutch engagement, and the radially-inner-side friction lining is provided with at least one groove which is in communication with a lockup release chamber in the lockup clutch.

In a further aspect of the present invention, there is a lockup clutch for a torque converter, wherein a friction lining is divided into a radially-outer-side friction lining and a radially-inner-side friction lining, μ-ν characteristics of the radially-outer-side friction lining have a positive gradient to inhibit occurrence of a shudder which takes place by a stick-slip, the radially-inner-side friction lining is equipped with a large coefficient of static friction to provide large torque capacity during a clutch engagement, and the radially-outer-side friction lining has a shape of a rectangle combined with a segment of a circle the chord of which lies on a side of the rectangle such that as viewed in an axial cross-section of the lockup clutch, the radially-outer-side friction lining is thicker at a radial center thereof and becomes thinner toward a radially outer end and radially inner end thereof while defining a bow-shaped contour.

In a still further aspect of the present invention, there is also provided a lockup clutch for a torque converter, wherein a friction lining is divided into a radially-outer-side friction lining and a radially-inner-side friction lining, μ-ν characteristics of said radially-outer-side friction lining have a positive gradient to inhibit occurrence of a shudder which takes place by a stick-slip, said radially-inner-side friction lining is equipped with a large coefficient of static friction to provide large torque capacity during a clutch engagement, and said radially-outer-side friction lining is provided with a continuous groove formed alongside an entire circumference thereof in the circumferential direction.

By providing the radially-outer-side friction lining with plural grooves formed with intervals therebetween in a circumferential direction or a continuous groove formed alongside an entire circumference thereof in the circumferential direction, a hydraulic pressure over a contact surface of the radially-outer-side friction lining becomes uniform in a circumferential direction, thereby making a shudder still harder to occur. By providing the radially-inner-side friction lining with plural radial grooves which are in communication with the lockup release chamber, the discharge of oil from the friction lining to a low-pressure side at the time of a clutch engagement is promoted, thereby making an oil film hard to be formed on the friction surface so that a transmittable torque can be increased.

By forming the radially-outer-side friction lining into the shape of the rectangle combined with the segment of the circle the chord of which lies on the side of the rectangle, the contact pressure becomes more uniform over the friction surface of the radially-outer-side friction lining, thereby making it possible to further heighten the effect of preventing the occurrence of a shudder.

Reflecting the recent demand for improvements in fuel economy, there is an increasing demand for lighter and smaller lockup clutches, and hence, an ever increasing demand for friction surfaces of greater torque capacity and also for smaller and lighter pistons. By adequately providing the radially-outer-side friction lining and/or the radially-inner-side friction lining with the corresponding at least one groove or making the improvements in the shape of the radially-outer-side friction lining, the resulting lockup clutch can meet these demands.

### BRIEF DESCRIPTION OF THE DRAWINGS

FIG. 1 is a cross-sectional view showing the fundamental construction of a torque converter equipped with a lockup clutch.

FIG. 2 is a front view of a piston in the lockup clutch as viewed at a friction surface of the piston.

FIG. 3 is cross-sectional view of the piston, taken in the direction of arrows III-III of FIG. 2.

FIG. 4 is a diagram showing a positive gradient of a friction lining.

FIG. 5 is a diagram showing a negative gradient of a friction lining.

FIG. 6 is a fragmentary front view of a piston in a lockup clutch according to a first embodiment of the present invention.

FIG. 7 is a fragmentary front view of a piston in a lockup clutch according to a second embodiment of the present invention.

FIG. 8 is a fragmentary cross-sectional view of a piston and front cover in a lockup clutch according to a third embodiment of the present invention.

FIG. 9 is a fragmentary cross-sectional view of a piston and front cover in a lockup clutch according to a fourth embodiment of the present invention, in which a seal member is arranged.

FIG. 10 is a fragmentary front view similar to FIG. 6, and illustrates a modification of the first embodiment shown in FIG. 6, in which a radially-outer-side friction lining is provided with a continuous groove formed alongside an entire circumference thereof in the circumferential direction.

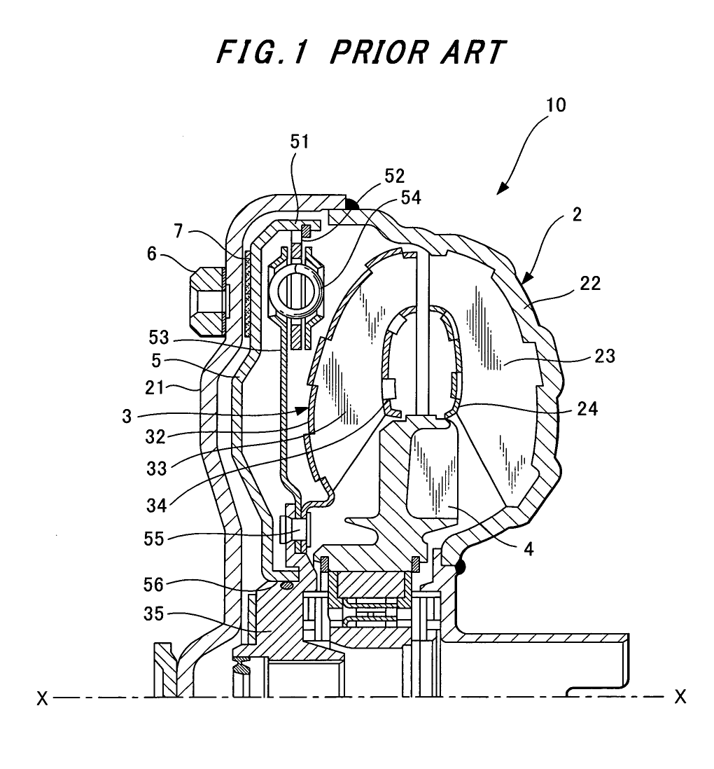

### DETAILED DESCRIPTION OF THE INVENTION AND PREFERRED EMBODIMENTS

Reflecting the recent demand for improvements in fuel economy, there has been an increasing demand for lighter and smaller lockup clutches. As a result, a piston has become still smaller and lighter so that upon a clutch engagement, the piston is flexed at a central part thereof toward a front cover. When a radially-outer-side friction lining is made thicker, the radially-outer-side friction lining firstly begins to come into contact with the front cover in an initial stage of a clutch engagement to perform slip control. At the time of completion of the clutch engagement, the radially-outer-side friction lining and a radially-inner-side friction lining are both brought at their entire surfaces into close contact with the front cover so that the torque capacity increases.

Although the radially-outer-side friction lining has its own sealing effect, the exhibition of sealing effect can be assured further when a seal member is arranged between the radially-outer-side friction lining and the radially-inner-side friction lining. By this sealing effect, oil is prevented from flowing around to the radially-inner-side friction lining. The seal member can, therefore, exhibit its effect for an increase in the torque capacity at the time of the completion of a clutch engagement.

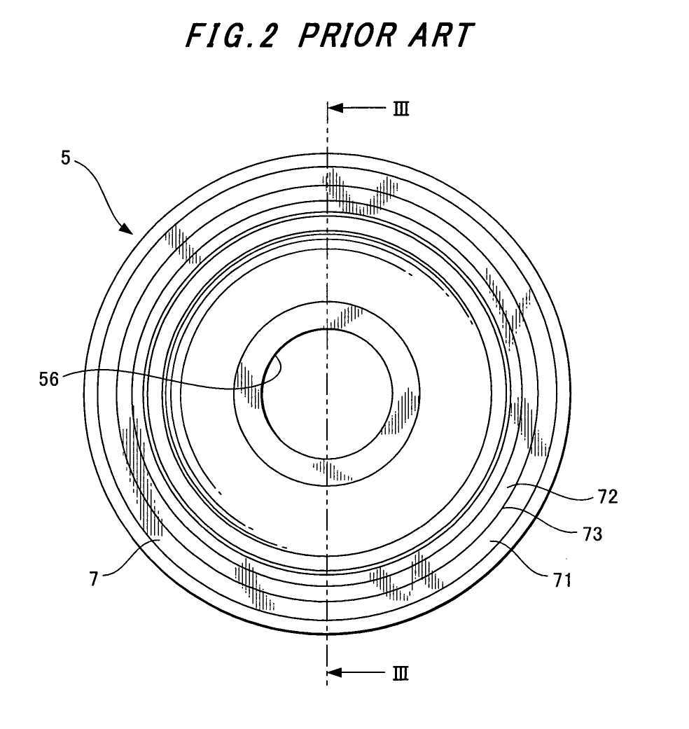

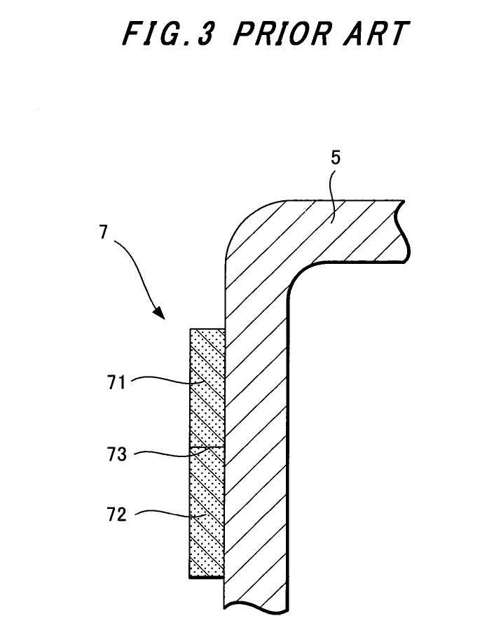

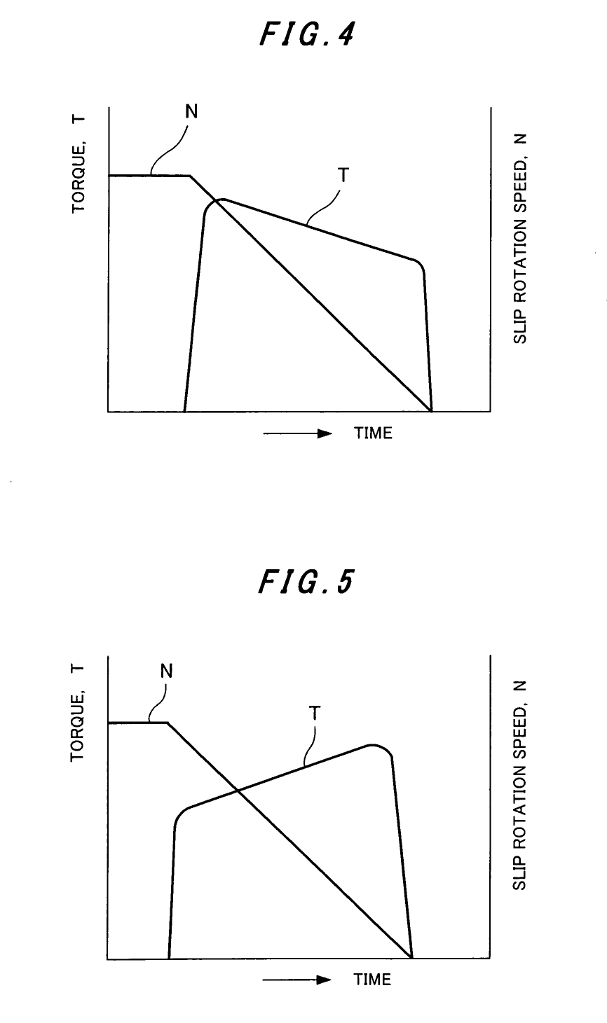

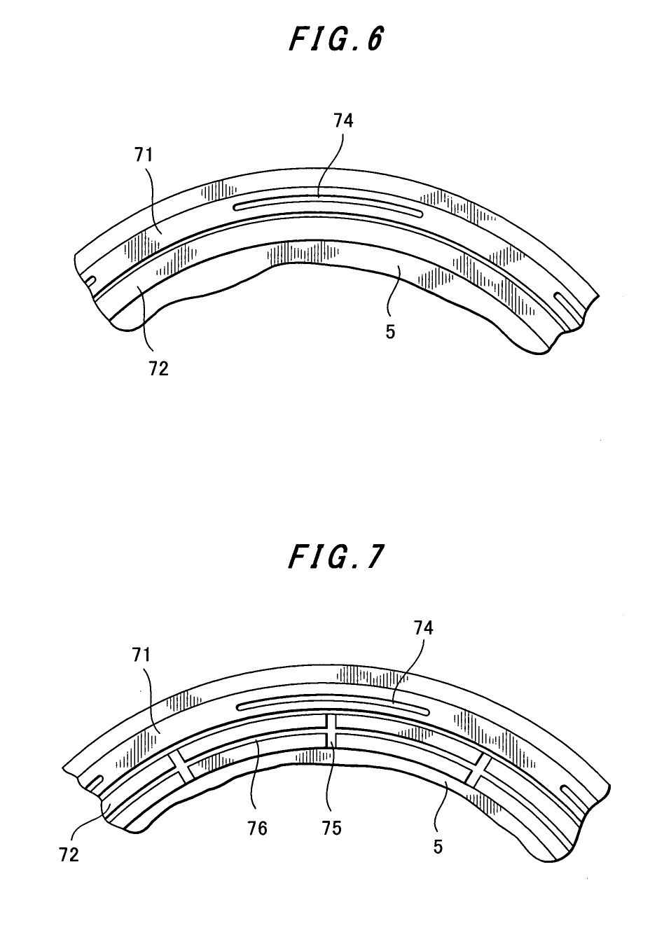

With reference to FIGS. 6 through 9, lockup clutches according to the first to fourth embodiments of the present invention will hereinafter be described. In FIGS. 6 through 9, those elements of the lockup clutches which are the same as or equivalent to their corresponding elements in FIG. 2 are shown by the same reference numerals.

FIG. 6 illustrates the first embodiment of the present invention, in which the present invention is applied to a radially-outer-side friction lining 71. The radially-outer-side friction lining 71 which performs slip control is provided with plural grooves 74 formed with intervals therebetween in a circumferential direction. Owing to the provision of the plural grooves 74, a hydraulic pressure over a contact surface of the radially-outer-side friction lining 71 becomes uniform in a circumferential direction, thereby making a shudder still harder to occur.

FIG. 7 depicts the second embodiment of the present invention, in which a radially-inner-side friction lining 72 is provided with radial grooves 75 which are in communication with the side of a lockup release chamber. Designated at numeral 76 is a continuous groove formed alongside an entire circumference of the radially-inner-side friction lining 72 in the circumferential direction such that oil over the contact surface of the radially-inner-side friction lining 72 can be smoothly collected into the grooves 75. It is, however, to be noted that the groove 76 is not essential but is optional. Owing to the provision of the grooves 75, the oil over the friction surface is allowed to promptly flow to a low-pressure side at the time of completion of a clutch engagement, thereby leaving the oil only in a small amount on the friction surface and resulting in increased torque capacity. Instead of arranging the radial grooves 75, a space defined between the radially-outer-side friction lining 71 and the radially-inner-side friction lining 72 may be used as a continuous groove extending alongside entire circumferences of the radially-outer-side and radially-inner-side friction linings 71,72 such that the continuous groove is in communication with the plural radial grooves 75. It is to be noted that, although the radially-outer-side friction lining and radially-inner- side friction lining are both provided with their corresponding grooves in FIG. 7, only one of the radially-outer-side friction lining and radially-inner-side friction lining may be provided with its corresponding grooves.

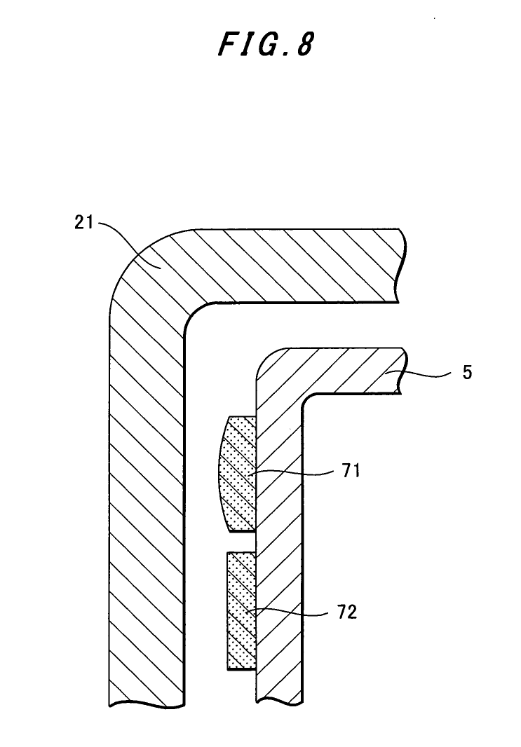

FIG. 8 illustrates the third embodiment of the present invention, in which a radially-outer-side friction lining 71 has a shape of a rectangle combined with a segment of a circle the chord of which lies on a side of said rectangle such that as viewed in an axial cross-section of the lockup clutch, the radially-outer-side friction lining 71 is thicker at a radial center thereof and becomes thinner toward a radially outer end and radially inner end thereof while defining a bow-shaped contour. By forming the radially-outer-side friction lining 71 as described above, the contact pressure becomes uniform in the circumferential direction, and the sealing effect that prevents the oil from flowing around to the radially-inner-side friction lining is increased. The radially-outer-side friction lining 71, therefore, exhibits its effect for the prevention of the occurrence of a shudder and for the increase in the torque capacity during a clutch engagement.

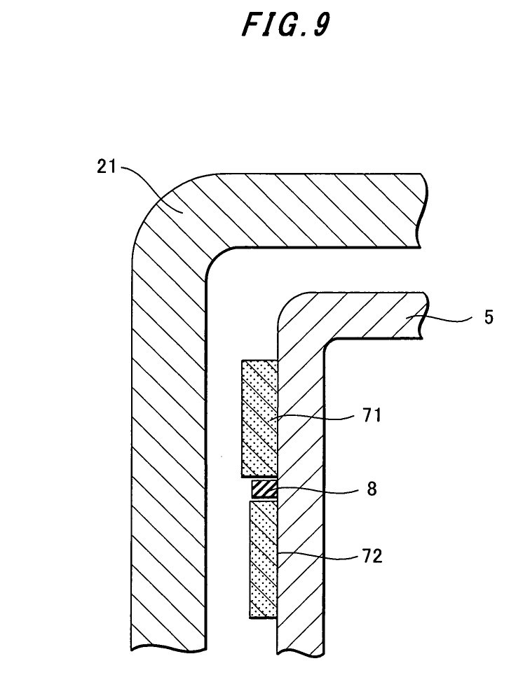

FIG. 9 shows the fourth embodiment of the present invention, in which a seal member 8 is arranged between a radially-outer-side friction lining 71 and a radially-inner-side friction lining 72. In FIG. 9, the radially-outer-side friction lining 71 is shown thicker than the radially-inner-side friction lining 72. It is to be noted that in all the above embodiments, the radially-outer-side friction lining can preferably be made thicker than the radially-inner-side friction lining. The provision of the seal member 8 further assures the exhibition of the above-mentioned effect that prevents the high-pressure oil from flowing around to the radially-inner-side friction lining 72.

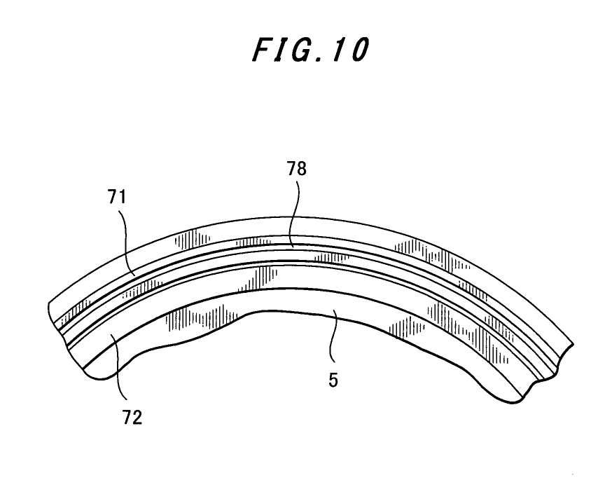

FIG. 10 illustrates a modification of the above-described first embodiment of the present invention. Instead of arranging the plural grooves 74, the radially-outer-side friction lining 71 is provided with a continuous groove 78 formed alongside the entire circumference thereof in the circumferential direction. This modification can bring about similar advantageous effects as the first embodiment.

This application claims the priority of Japanese Patent Application 2005-340492 filed Nov. 25, 2005, which is incorporated herein by reference.

1. A lockup clutch for a torque converter, wherein a friction lining is divided into a radially-outer-side friction lining and a radially-inner-side friction lining, μ-ν characteristics of said radially-outer-side friction lining have a positive gradient to inhibit occurrence of a shudder which takes place by a stick-slip, said radially-inner-side friction lining is equipped with a large coefficient of static friction to provide large torque capacity during a clutch engagement, and said radially-outer-side friction lining is provided with plural grooves formed with intervals therebetween in a circumferential direction.

2. A lockup clutch according to claim 1, wherein said radially-outer-side friction lining has a shape of a rectangle combined with a segment of a circle the chord of which lies on a side of said rectangle such that as viewed in an axial cross-section of said lockup clutch, said radially-outer-side friction lining is thicker at a radial center thereof and becomes thinner toward a radially outer end and radially inner end thereof while defining a bow-shaped contour.

3. A lockup clutch according to claim 1, wherein said radially-outer-side friction lining is thicker than said radially-inner-side friction lining.

4. A lockup clutch according to claim 1, further comprising a seal member arranged between said radially-outer-side friction lining and said radially-inner-side friction lining on a side of one of said piston and a front cover in said lockup clutch.

5. A lockup clutch according to claim 1, wherein said radially-inner-side friction lining is provided with plural radial grooves which are in communication with a lockup release chamber in said lockup clutch.

6. A lockup clutch according to claim 5, wherein said radially-outer-side friction lining has a shape of a rectangle combined with a segment of a circle the chord of which lies on a side of said rectangle such that as viewed in an axial cross-section of said lockup clutch, said radially-outer-side friction lining is thicker at a radial center thereof and becomes thinner toward a radially outer end and radially inner end thereof while defining a bow-shaped contour.

7. A lockup clutch for a torque converter, wherein a friction lining is divided into a radially-outer-side friction lining and a radially-inner-side friction lining, μ-ν characteristics of said radially-outer-side friction lining have a positive gradient to inhibit occurrence of a shudder which takes place by a stick-slip, said radially-inner-side friction lining is equipped with a large coefficient of static friction to provide large torque capacity during a clutch engagement, and said radially-inner-side friction lining is provided with plural radial grooves which are in communication with a lockup release chamber in said lockup clutch.

8. A lockup clutch according to claim 7, wherein said radially-outer-side friction lining has a shape of a rectangle combined with a segment of a circle the chord of which lies on a side of said rectangle such that as viewed in an axial cross-section of said lockup clutch, said radially-outer-side friction lining is thicker at a radial center thereof and becomes thinner toward a radially outer end and radially inner end thereof while defining a bow-shaped contour.

9. A lockup clutch according to claim 7, wherein said radially-inner-side friction lining is additionally provided with a continuous groove formed alongside an entire circumference thereof in the circumferential direction such that said continuous groove is in communication with said plural radial grooves.

10. A lockup clutch according to claim 7, wherein a continuous groove is defined alongside entire circumferences of said radially-outer-side and radially-inner-side friction linings such that said continuous groove is in communication with said plural radial grooves.

11. A lockup clutch for a torque converter, wherein a friction lining is divided into a radially-outer-side friction lining and a radially-inner-side friction lining, μ-ν characteristics of said radially-outer-side friction lining have a positive gradient to inhibit occurrence of a shudder which takes place by a stick-slip, said radially-inner-side friction lining is equipped with a large coefficient of static friction to provide large torque capacity during a clutch engagement, and said radially-outer-side friction lining has a shape of a rectangle combined with a segment of a circle the chord of which lies on a side of said rectangle such that as viewed in an axial cross-section of said lockup clutch, said radially-outer-side friction lining is thicker at a radial center thereof and becomes thinner toward a radially outer end and radially inner end thereof while defining a bow-shaped contour.

12. A lockup clutch for a torque converter, wherein a friction lining is divided into a radially-outer-side friction lining and a radially-inner-side friction lining, μ-ν characteristics of said radially-outer-side friction lining have a positive gradient to inhibit occurrence of a shudder which takes place by a stick-slip, said radially-inner-side friction lining is equipped with a large coefficient of static friction to provide large torque capacity during a clutch engagement, and said radially-outer-side friction lining is provided with a continuous groove formed alongside an entire circumference thereof in the circumferential direction.

13. A lockup clutch according to claim 12, wherein said radially-outer-side friction lining has a shape of a rectangle combined with a segment of a circle the chord of which lies on a side of said rectangle such that as viewed in an axial cross-section of said lockup clutch, said radially-outer-side friction lining is thicker at a radial center thereof and becomes thinner toward a radially outer end and radially inner end thereof while defining a bow-shaped contour.

14. A lockup clutch according to claim 12, wherein said radially-outer-side friction lining is thicker than said radially-inner-side friction lining.

15. A lockup clutch according to claim 12, further comprising a seal member arranged between said radially-outer-side friction lining and said radially-inner-side friction lining on a side of one of said piston and a front cover in said lockup clutch.

16. A lockup clutch according to claim 12, wherein said radially-inner-side friction lining is provided with plural radial grooves which are in communication with a lockup release chamber in said lockup clutch.

17. A lockup clutch according to claim 16, wherein said radially-outer-side friction lining has a shape of a rectangle combined with a segment of a circle the chord of which lies on a side of said rectangle such that as viewed in an axial cross-section of said lockup clutch, said radially-outer-side friction lining is thicker at a radial center thereof and becomes thinner toward a radially outer end and radially inner end thereof while defining a bow-shaped contour.
